(19) United States
(12) Patent Application Publication
(10) Pub. No.: US 2014/0204048 A1
(43) Pub. Date: Jul. 24, 2014

(54) TOUCH ELECTRODE DEVICE

(71) Applicant: HENGHAO TECHNOLOGY CO. LTD, Taoyuan County (TW)

(72) Inventors: Chien-Wen Lai, New Taipei City (TW); Wei-Wen Wang, Taipei City (TW)

(73) Assignee: HENGHAO TECHNOLOGY CO. LTD, Taoyuan County (TW)

(21) Appl. No.: 13/751,140

(22) Filed: Jan. 27, 2013

(30) Foreign Application Priority Data
Jan. 22, 2013 (TW) 102102278

(51) Int. Cl. G06F 3/044

(52) U.S. Cl. CPC G06F 3/044
USPC 345/174

(57) ABSTRACT

A touch electrode device includes first electrode lines and second electrode lines formed on a transparent substrate. An insulating block is disposed at a junction between a first conductive connecting portion of the first electrode line and a second conductive connecting portion of the second electrode line. Insulating lines are respectively extended from the insulating blocks along the first electrode line, and are disposed in gaps between the first electrodes and the adjacent second electrodes.

### CROSS-REFERENCE TO RELATED APPLICATIONS

The entire contents of Taiwan Patent Application No. 102102278, filed on Jan. 22, 2013, from which this application claims priority, are incorporated herein by reference.

### BACKGROUND OF THE INVENTION

1. Field of the Invention

The present invention generally relates to a touch panel, and more particularly to a touch electrode device with insulating blocks and insulating lines.

2. Description of Related Art

A touch screen is an input/output device that adopts sensing technology and display technology, and has been widely employed in electronic devices such as portable or hand-held electronic devices.

A capacitor-based touch panel is a commonly used touch panel that utilizes capacitive coupling effect to detect touch position. Specifically, capacitance corresponding to the touch position changes and is thus detected, when a finger touches a surface of the touch panel.

FIG. 1 shows a top view of a conventional touch panel 200 disclosed in U.S. Pat. No. 6,188,391. The conventional touch panel 200 is composed of vertical electrode lines 21 and horizontal electrode lines 22. Elongated insulating blocks 23 are used to electrically insulate the vertical electrode lines 21 from the horizontal electrode lines 22. The width of the elongated blocks 23, however, is so wide that light transmittance of the touch panel 200 is disadvantageously reduced. Further, trace phenomenon may occur to impact visual appearance when users look at the touch panel 200.

A need has thus arisen to propose a novel touch electrode device to overcome deficiencies of the conventional touch panels.

### SUMMARY OF THE INVENTION

In view of the foregoing, it is an object of the embodiment of the present invention to provide a touch electrode device to increase light transmittance and sensitivity, and to prevent trace phenomenon.

According to one embodiment, a touch electrode device includes a transparent substrate, a plurality of first electrode lines, a plurality of second electrode lines, a plurality of insulating blocks and a plurality of insulating lines. The first electrode lines are formed on the transparent substrate, each said first electrode line including a plurality of first electrodes, a first conductive connecting portion being disposed between adjacent first electrodes of a same first electrode line. The second electrode lines are formed on the transparent substrate, each said second electrode line including a plurality of second electrodes, a second conductive connecting portion being disposed between adjacent second electrodes of a same second electrode line. The insulating blocks are disposed at junctions between the first conductive connecting portions and the second conductive connecting portions, respectively. The insulating lines are respectively extended from the insulating blocks along the first electrode line, and are disposed in gaps between the first electrodes and the adjacent second electrodes.

### BRIEF DESCRIPTION OF THE DRAWINGS

FIG. 1 shows a top view of a conventional touch panel;

FIG. 2 shows a partial top view of a touch electrode device according to a first embodiment of the present invention; and

FIG. 3 shows a partial top view of a touch electrode device according to a second embodiment of the present invention.

### DETAILED DESCRIPTION OF THE INVENTION

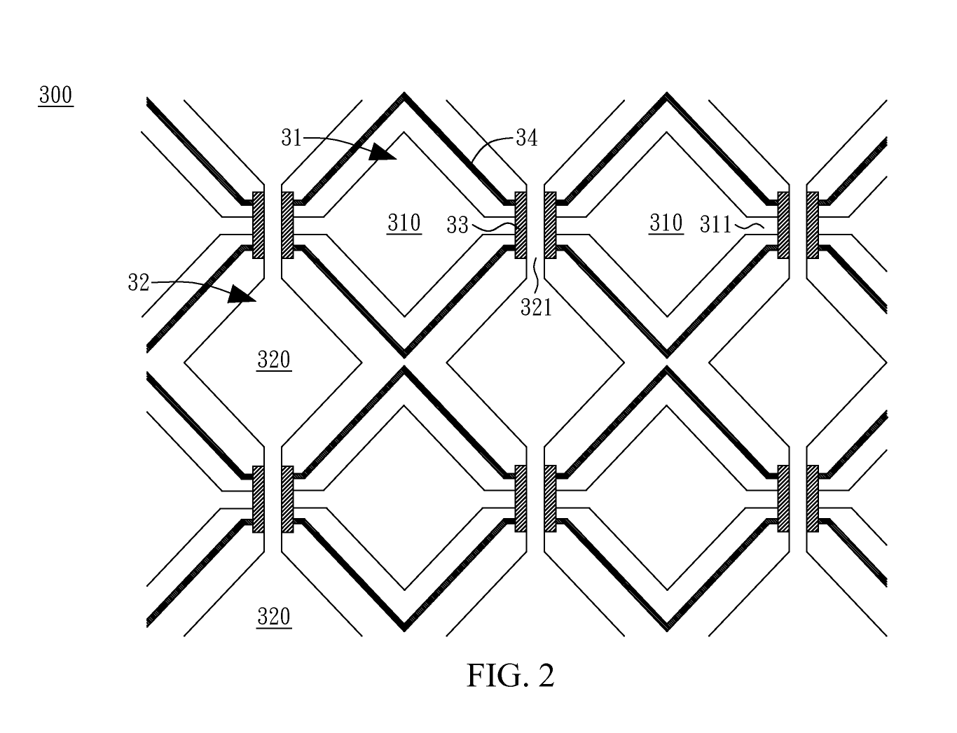

FIG. 2 shows a partial top view of a touch electrode device 300 according to a first embodiment of the present invention. In the embodiment, the touch electrode device 300 mainly includes plural first electrode lines 31 and plural second electrode lines 32 formed on a transparent substrate (not shown). The first electrode lines 31 may be substantially parallel to each other, and the second electrode lines 32 may be substantially parallel to each other. The first electrode lines 31 may, but not necessarily, be substantially perpendicular to the second electrode lines 32. The transparent substrate may include insulating material such as glass, Polycarbonate (PC), Polyethylene terephthalate (PET), Polyethylen (PE), Poly vinyl chloride (PVC), Poly propylene (PP), Poly styrene (PS), Poly-methyl methacrylate (PMMA) or Cyclic olefin copolymer (COC).

In one embodiment, the first electrode line 31 and the second electrode line 32 may include a light-transmissive structure made of a non-transparent material. The non-transparent material may include metal nanowires (e.g., silver nanowires or copper nanowires) or metal nanonets (e.g., silver nanonets or copper nanonets). The metal nanowires or nanonets have a diameter in a nanometer order (i.e., a few nanometers to hundreds nanometers), and may be fixed via a plastic material (e.g., resin). Due to fineness of the metal nanowires/nanonets unobservable to human eyes, the first electrode line 31 and the second electrode line 32 made of the metal nanowires/nanonets thus have high light-transmittance. The first electrode line 31 and the second electrode line 32 may further include a photosensitive material (e.g., acrylic), through which electrodes with a required pattern may be formed via an exposure development process.

In another embodiment, the first electrode line 31 and the second electrode line 32 may include a light-transmissive structure made of a transparent material. The transparent material may include indium tin oxide (ITO), indium zinc oxide (IZO), Al-doped ZnO (AZO) or antimony tin oxide (ATO).

The first electrode line 31 is composed of plural first electrodes 310. A first conductive connecting portion 311 is disposed, and electrically connected, between adjacent first electrodes 310 of the same first electrode line 31. The second electrode line 32 is composed of plural second electrodes 320. A second conductive connecting portion 321 is disposed, and electrically connected, between adjacent second electrodes 320 of the same second electrode line 32. The second conductive connecting portion 321 may include metal conductor. The first electrodes 310 and the second electrodes 320 may be designed to a shape other than the rhombus shape as exemplified in FIG. 2.

As shown in FIG. 2, an insulating block 33 is disposed at a junction between the first conductive connecting portion 311 of the first electrode line 31 and the second conductive connecting portion 321 of the second electrode line 32 in order to electrically insulate the first electrode line 31 from the second electrode line 32. In one embodiment, the insulating block 33 has a quadrilateral shape with each side of about 80-250 micrometers, and the first conductive connecting portion 311 and the second conductive connecting portion 321 have a width of about 40-80 micrometers.

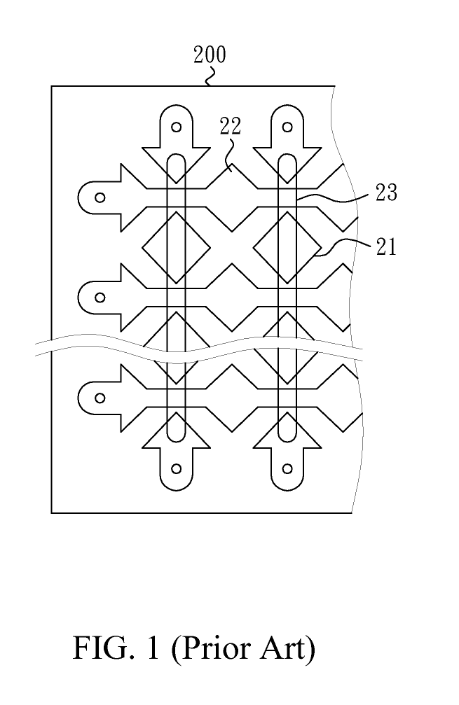

According to one aspect of the embodiment, at least one insulating line 34 is extended from the insulating block 33 and disposed along the first electrode line 31. The insulating line 34 is disposed in gaps between the first electrodes 310 and the adjacent second electrodes 320. As shown in FIG. 2, two insulating lines 34 are disposed along two sides of the first electrode 310 respectively such that the first electrode 310 is surrounded by the insulating lines 34. The insulating line 34 may be disposed in a center of the gap, or may be disposed near one kind of electrode (e.g., the first electrode 310) than the other kind of electrode (e.g., the second electrode 320). In the embodiment, the gap between the first electrode 310 and the adjacent second electrode 320 has a distance of 20-50 micrometers, preferably about 30 micrometers; and the insulating lines 34 have a width of 5-20 micrometers, preferably about 10 micrometers. Compared with the elongated insulating block (e.g., 23 in FIG. 1) of the conventional touch panel, the width of the insulating lines 34 of the embodiment is so narrow that the light transmittance of the touch panel cannot be impacted. Moreover, as the insulating lines 34 are disposed in the gaps between the first electrodes 310 and the adjacent second electrodes 320, the sensitivity of the touch panel cannot be affected.

As shown in FIG. 2, the insulating blocks 33 and the insulating lines 34 may be integrally formed, or may be individually formed. In case that they are individually formed, the insulating blocks 33 may be formed before forming the insulating lines 34, or the insulating lines 34 may be formed before forming the insulating blocks 33. The insulating blocks 33 and the insulating lines 34 may include silicon dioxide, acrylics or optically clear adhesive (OCA). The insulating blocks 33 and the insulating lines 34 may further include a photosensitive material, through which a required pattern may be formed via an exposure development process.

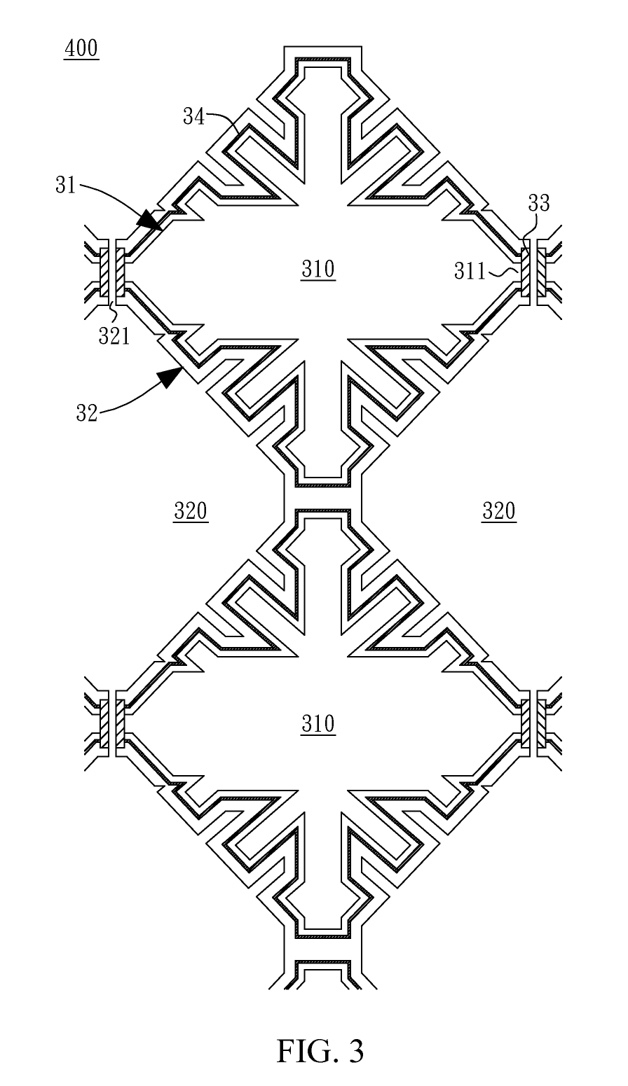

FIG. 3 shows a partial top view of a touch electrode device 400 according to a second embodiment of the present invention. Composing elements being the same as those in the first embodiment (FIG. 2) are denoted with the same labels. Compared with the first embodiment, the first electrodes 310 of the present embodiment have a modified rhombus shape with saw-toothed sides, and the second electrodes 320 have a shape that complements the shape of the first electrodes 310. According to the electrode pattern of the present embodiment, as adjacent area between the first electrodes 310 and the second electrodes 320 increases, the touch sensitivity and efficiency are therefore enhanced accordingly. Similar to the previous embodiment, at least one insulating line 34 is extended from the insulating block 33, and disposed in the gaps between the first electrodes 310 and the second electrodes 320 along the direction of the first electrode line 31.

Although specific embodiments have been illustrated and described, it will be appreciated by those skilled in the art that various modifications may be made without departing from the scope of the present invention, which is intended to be limited solely by the appended claims.

What is claimed is:

1. A touch electrode device, comprising:
a transparent substrate;
a plurality of first electrode lines formed on the transparent substrate, each said first electrode line including a plurality of first electrodes, a first conductive connecting portion being disposed between adjacent first electrodes of a same first electrode line;
a plurality of second electrode lines formed on the transparent substrate, each said second electrode line including a plurality of second electrodes, a second conductive connecting portion being disposed between adjacent second electrodes of a same second electrode line;
a plurality of insulating blocks disposed at junctions between the first conductive connecting portions and the second conductive connecting portions, respectively; and
a plurality of insulating at least one of which being extended from the insulating block along the first electrode line, the insulating line being disposed in gaps between the first electrodes and the adjacent second electrodes.

2. The device of claim 1, wherein the first electrodes have a rhombus shape.

3. The device of claim 2, wherein the rhombus-shaped first electrodes have saw-toothed sides.

4. The device of claim 1, wherein the gaps between the first electrodes and the adjacent second electrodes have a distance of 20-50 micrometers, and the insulating lines have a width of 5-20 micrometers.

5. The device of claim 1, wherein the insulating block has a quadrilateral shape with each side of about 80-250 micrometers, and the first conductive connecting portion and the second conductive connecting portion have a width of about 40-80 micrometers.

6. The device of claim 1, wherein the insulating blocks or the insulating lines comprise silicon dioxide, acrylics or optically clear adhesive (OCA).

7. The device of claim 1, wherein the insulating blocks or the insulating lines comprise a photosensitive material.

8. The device of claim 1, wherein the first electrode line or the second electrode line comprises a light-transmissive structure made of a non-transparent material.

9. The device of claim 8, wherein the non-transparent material comprises a plurality of metal nanowires or metal nanonets.

10. The device of claim 1, wherein the first electrode line or the second electrode line comprises a photosensitive material.

11. The device of claim 1, wherein the first electrode line or the second electrode line comprises a light-transmissive structure made of a transparent material.

12. The device of claim 11, wherein the transparent material comprises indium tin oxide (ITO), indium zinc oxide (IZO), Al-doped ZnO (AZO) or antimony tin oxide (ATO).
